(19) United States
(12) Patent Application Publication
(10) Pub. No.: US 2005/0136745 A1
(43) Pub. Date: Jun. 23, 2005

(54) Adaptor DC output plug

(75) Inventor: Chen-Yu Li, Taoyuan City (TW)

Correspondence Address: TROXELL LAW OFFICE PLLC, SUITE 1404, 5205 LEESBURG PIKE, FALLS CHURCH, VA, 22041, US

(73) Assignee: SPI Electronic Co., Ltd.

(21) Appl. No.: 10/971,056

(22) Filed: Oct. 25, 2004

(30) Foreign Application Priority Data
Oct. 28, 2003 (TW) 092219157

(51) Int. Cl. H01R 25/00

(52) U.S. Cl. 439/638

(57) ABSTRACT

A power adaptor DC output plug includes a case, one end of the case being a receptor to a power source and another end connected to a power cable and DC output plug adaptable to different forms of power receptor so to supply the converted power supply to the power receiving device; a locking device being formed between the DC output plus and where the contact surface of the plug of the power receiving device to maintain unity of insertion between the DC output plug and connector to assure of correct conduction of polarities.

### BACKGROUND OF THE INVENTION

(a) Field of the Invention

The present invention is related to a DC output plug of an adaptor, and more particularly to one that is provided with a locking device to prevent mistake of polarities while the DC output plug and a connector are plugged into each other.

(b) Description of the Prior Art

The primary purpose of a portable power supply is to rectify and convert the commercial power source into DC for supplying power to a power-receiving device including printer, radio, and modem. Adaptor and charger are two essential types of the portable power supply.

As illustrated in FIG. 1 of the accompanying drawings, a construction of an adaptor 1 generally available in the market is essentially comprised of a case 11, one end of the case 11 relates to a power-receiving jack 111. A cable 162 with one end provided with a connector 161 to plug into the power receiving jack 111 with an AC plug 12, and another plug 163 to plug into a wall socket (not illustrated) to constitute a continuity for receiving the commercial power source. Another end of the case 11 relates to a power outlet jack 112 connected to a power cable 14 and a DC output plug 15 to be inserted into a connector 21 of a power-receiving device 2 so to supply the converted power to the power-receiving device 2. The DC plug 15 is adaptable to the insertion by the connector 21 in various forms for the adaptor 1 to supply power to the power-receiving device. However, when the connector 21 is plugged into the DC output plug 15 as illustrated in FIG. 2, both of a positive terminal 211 and a negative terminal 212 must be respectively and exactly plugged into a positive and a negative jacks 151, 152. However, either on the DC output plug 15 or the connector 21 there is the absence of a significant marking of the polarities to facilitate the plug in with correct polarities fail the normal power supply by the adaptor or even damage the internal circuit of the power-receiving device.

### SUMMARY OF THE INVENTION

The primary purpose of the present invention is to provide an improved construction for the DC output plug of an adaptor to avoid mistakes of plugging into wrong polarities. To achieve the purpose, the adaptor is essentially comprised of a case. One end of the case relates to a power-receiving end and the other end of the case is connected to a cable and the DC output plug. The DC output plug is adaptable to a plug from various forms of a power-receiving device so to supply the converted power to the power-receiving device. Wherein, a locking device is formed at where the DC output plug contacts the connector of the power-receiving device plugged into the DC output plug to maintain unity of the plug of the connector and the DC output plug while permitting the proper conduction between the positive and negative polarities and those from the connector.

### BRIEF DESCRIPTION OF THE DRAWINGS

FIG. 1 is a perspective view of an adaptor of the prior art.

FIG. 2 is an exploded view showing a DC output plug and a connector of the adaptor of the prior art are about to connecting to each other.

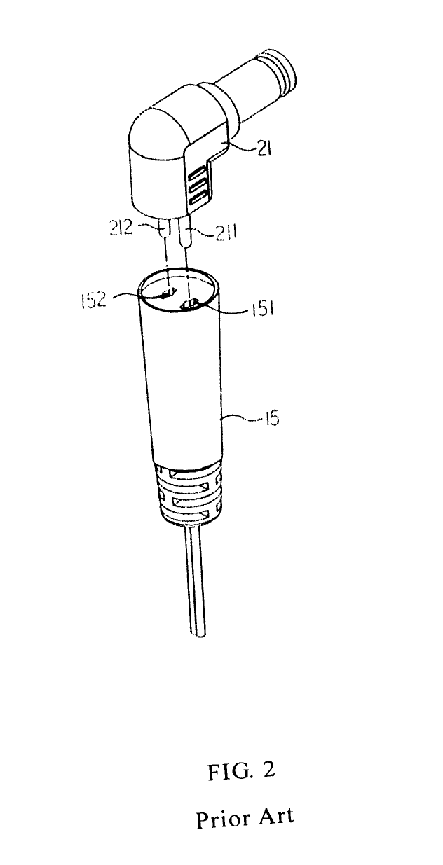

FIG. 3 is an exploded view showing that a DC output plug and a connector of the present invention are about to connecting to each other.

FIG. 4 is a schematic view showing that the DC output plug and the connected of the present invention are connected to each other.

FIG. 5 is a schematic view showing another working status of the DC output plug and the connector of the present invention are connected to each other.

FIG. 6 is a schematic view showing another preferred embodiment of the present invention.

FIG. 7 is a schematic view showing another preferred embodiment yet of the present invention.

### DETAILED DESCRIPTION OF THE PREFERRED EMBODIMENTS

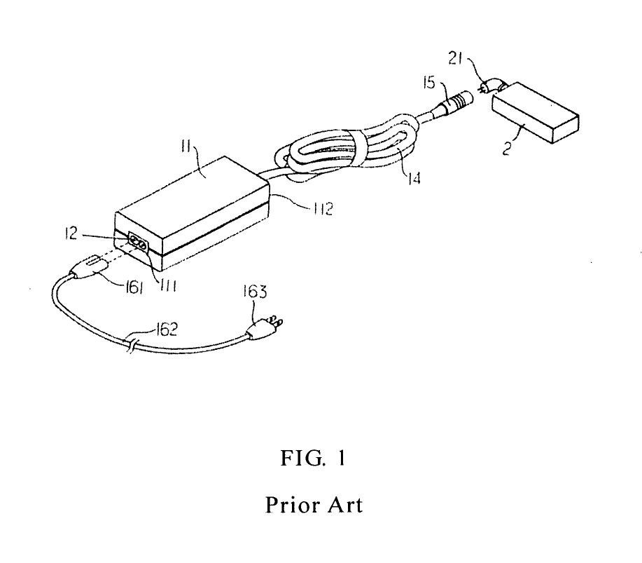

The present invention relates to an improved construction of a DC output plug of an adaptor 1. The adaptor 1, the same as that illustrated in FIG. 1, essentially includes a case 11 with one end of the case 11 related to a power receiving end 111 to receive the power and the other end of the case 11 related to a power output end 112 connected to a power cable 14 and a DC output plug 17. The DC output plug 17 permits to be plugged by a connector from a power-receiving device 2 of various forms so to supply the converted power to the power-receiving device 2.

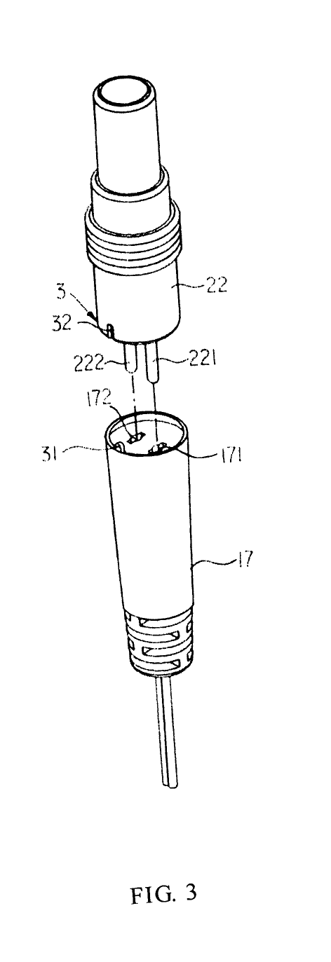

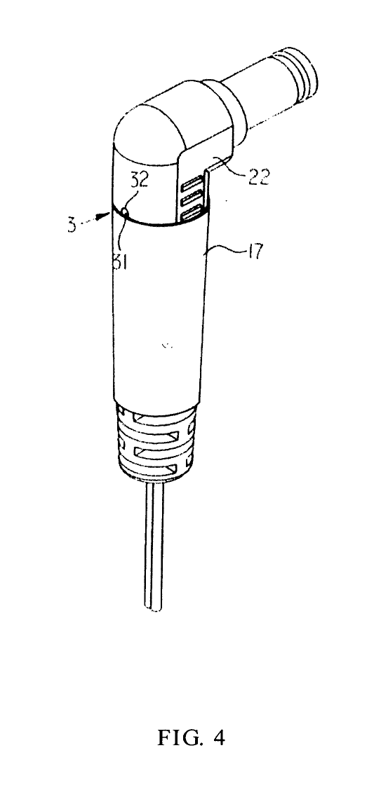

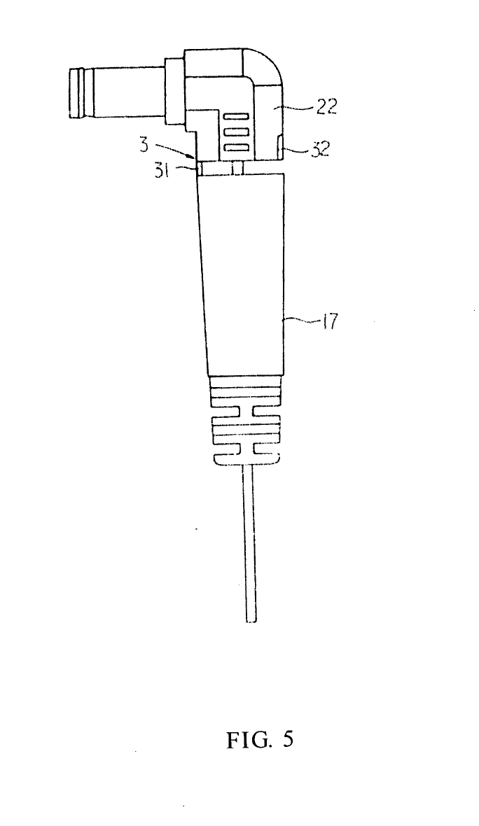

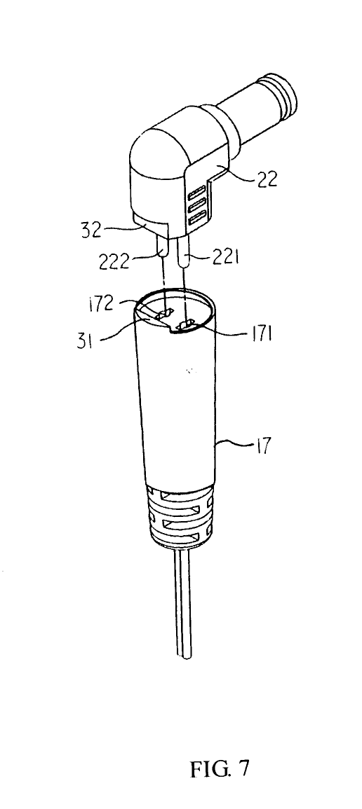

As illustrated in FIGS. 3 and 4, a locking device 3 is provided at where both of the DC output plug 17 and the connector 22 are plugged into each other. The locking device 3 is comprised of a locking bit 31 provided on the DC output plug 17 and a slot 32 disposed on the connector 22 at where in relation to the locking bit 31 to maintain the unity of the DC output plug 17 and the connector plugged into each other. Accordingly, both of a positive and a negative terminals 221, 222 of the connector 22 are correctly inserted into both corresponding positive and negative sockets 171, 172 of the DC output plug 17 while conducting the positive and the negative polarities of the DC output plug 17 and the connector 22 to avoid mistake of polarities. The shape of the locking bit 31 and the locking slot 32 may be made as that illustrated in FIG. 7. If the user makes mistake about the polarities when plugging the connector 22 into the DC output plug 17, the locking bit 31 fails to engage the locking slot 32 thus to frustrate the connection of the connector 22 into the DC output plug 17 as illustrated in FIG. 5. Therefore, both of the DC output plug 17 and the connector 22 are prevented from being conducted to avoid damage to internal circuit of the power-receiving device.

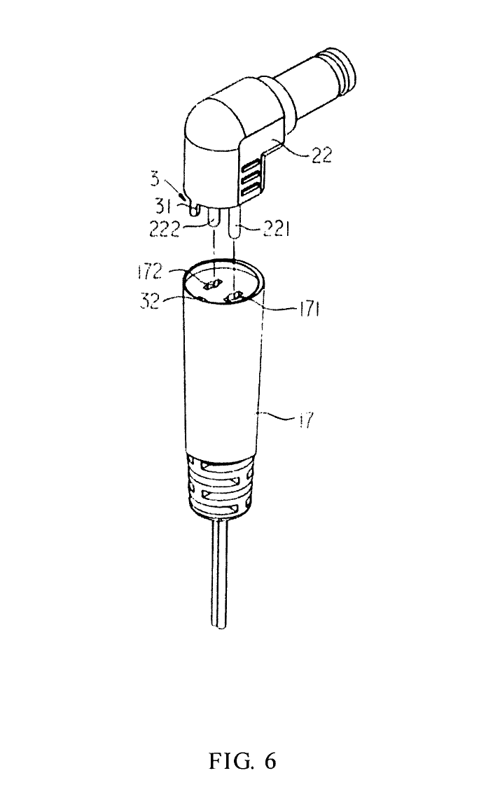

Furthermore, the DC output plug 17 is adaptable to the connector 22 of different form. As illustrated in FIG. 6, the locking device 3 as illustrated in FIG. 6 has its locking bit 31 provided to the connector 22 and the locking slot 32 provided to the DC outlet plug 17 at where in relation to the locking bit 31 when both of the DC output plug 17 and the connector contact each other.

The improved construction of the DC output plug of the adapter by the installation of the locking device assures of the correct conduction between both polarities of the DC output plug and both polarities of the connector to avoid mistake about the polarities. Therefore, this application for a utility patent is duly filed; however, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

1. An adaptor DC output plug is comprised of a case; one end of the case to receive power and the other end of the case being connected to a power cable and the DC output plug; the DC output plug being adaptable to the insertion of a connector from a power-receiving device of various forms to supply converted power to the power-receiving device; and a locking device provided at where the DC output plug and the connector contact each other to maintain unity of both the DC output plug and the connector inserted into each other.

2. The adaptor DC output plug of claim 1, wherein, the locking device comprised of a locking bit and a locking slot; the locking bit being provided on the connector at where the connector contacts the DC output plug; and the locking slot being provided on the DC output plug in relation to the locking bit at where the DC output plug contacts the connector.

3. The adaptor DC output plug of claim 1, wherein, the locking device is comprised of a locking bit and a locking slot; the locking bit being provided on DC output plug of an output end of a power source at where the connector is inserted into the DC output plug; and the locking slot being provided to the connector at where in relation to the locking bit when it is inserted into the DC output plug.
